(19) United States
(12) Patent Application Publication
(10) Pub. No.: US 2024/0387799 A1
(43) Pub. Date: Nov. 21, 2024

(54) SILICON/CARBON ANODE COMPOSITE FOR LITHIUM SECONDARY BATTERY, MANUFACTURING METHOD THEREOF, AND LITHIUM SECONDARY BATTERY COMPRISING THE SAME

(71) Applicant: UIF (University Industry Foundation), Yonsei University, Seoul (KR)

(72) Inventor: Jong Hyeok PARK, Seoul (KR)

(73) Assignee: UIF (University Industry Foundation), Yonsei University, Seoul (KR)

(21) Appl. No.: 18/396,778

(22) Filed: Dec. 27, 2023

(30) Foreign Application Priority Data
Mar. 20, 2023 (KR) 10-2023-0035893

(51) Int. Cl. H01M 4/36; C01B 32/21; H01M 4/02; H01M 4/587; H01M 4/60; H01M 10/052

(52) U.S. Cl. CPC H01M 4/366; C01B 32/21; H01M 4/587; H01M 4/604; H01M 10/052; C01P 2006/40; H01M 2004/021; H01M 2004/027

(57) ABSTRACT

The present disclosure relates to a silicon/carbon anode composite for a lithium secondary battery, a method for preparing the same and a lithium secondary battery including the same. Particularly, the silicon/carbon anode composite for a lithium secondary battery is obtained by coating the surface of silicon microparticles with a polymer or pitch and allowing the resultant product to be physicochemically bound to the surface of the carbonaceous material through a mechanofusion process, and thus needs no additional heat treatment and can be processed with ease, is prevented from volumetric swelling of silicon caused by lithium-ion intercalation and deintercalation, and can provide a battery with significantly improved capacity and life characteristics.

### CROSS-REFERENCE TO RELATED APPLICATION

This application claims priority to Korean Patent Application No. 10-2023-0035893 filed on Mar. 20, 2023, and all the benefits accruing therefrom under 35 U.S.C. § 119, the contents of which in its entirety are herein incorporated by reference.

### BACKGROUND

### 1. Field

The present disclosure relates to a silicon/carbon anode composite, a method for preparing the same and a lithium secondary battery including the same.

### 2. Description of the Related Art

As technological development and needs for mobile instruments have been increased, secondary batteries as energy sources have been increasingly in demand rapidly. Among such secondary batteries, lithium secondary batteries having high energy density and voltage, long cycle life and low self-discharge rate have been commercialized and used widely.

As a cathode active material for such lithium secondary batteries, lithium composite metal oxides have been used. In addition, graphite capable of lithium intercalation and deintercalation has been used typically as an anode active material for such lithium secondary batteries. However, since an electrode using graphite has a low electric charge capacity, there has been a limitation in providing a lithium secondary battery showing excellent capacity characteristics.

Therefore, inorganic active materials, such as silicon (Si), germanium (Ge) or antimony (Sb), have been studied. Particularly, a silicon-based anode active material among such inorganic active materials has a high lithium binding capacity, and thus can realize a high theoretical capacity.

However, an inorganic anode active material, such as silicon, causes a large change in volume during the lithium intercalation and deintercalation, i.e. during the charge/discharge of a battery, resulting in pulverization. In addition, such an anode active material is separated from a current collector to cause a contact loss among the active materials.

To solve the above-mentioned disadvantages of the silicon materials, some studies have been conducted according to the related art to form a composite by coating the surface of graphite with silicon. However, such a composite has a limitation in that it provides a battery with low performance, because the surface coating is not performed satisfactorily due to a difference in surface energy between silicon and graphite.

### REFERENCE

### Patent Documents

(Patent Document 1) Korean Patent Publication No. 10-1219171

### SUMMARY

The present disclosure is directed to providing a silicon/carbon anode composite for a lithium secondary battery which needs no additional heat treatment and can be processed with ease, prevents volumetric swelling of silicon caused by lithium-ion intercalation and deintercalation, and provides a battery with significantly improved capacity and life characteristics.

The present disclosure is also directed to providing an anode active material for a lithium secondary battery including the silicon/carbon anode composite according to the present disclosure.

In addition, the present disclosure is directed to providing an anode for a lithium secondary battery including the anode active material according to the present disclosure.

In addition, the present disclosure is directed to providing a lithium secondary battery including the anode according to the present disclosure.

In addition, the present disclosure is directed to providing a device including the lithium secondary battery according to the present disclosure.

Further, the present disclosure is directed to providing an electric device including the anode for a lithium secondary battery according to the present disclosure.

In one aspect, there is provided a silicon/carbon anode composite for a lithium secondary battery, including: a carbonaceous material; and silicon nanoparticles bound to the surface of the carbonaceous material, wherein the silicon nanoparticles are surface-coated with a polymer or pitch.

In another aspect, there is provided an anode active material for a lithium secondary battery including the silicon/carbon anode composite according to the present disclosure.

In still another aspect, there is provided an anode for a lithium secondary battery including the anode active material according to the present disclosure.

In still another aspect, there is provided a lithium secondary battery including the anode according to the present disclosure.

In still another aspect, there is provided a device which includes the lithium secondary battery according to the present disclosure and is any one selected from communication devices, transport devices and energy storage devices.

In still another aspect, there is provided an electric device which includes the anode for a lithium secondary battery according to the present disclosure and is any one selected from electric vehicles, hybrid electric vehicles, plug-in hybrid electric vehicles and electric power storage devices.

In yet another aspect, there is provided a method for preparing a silicon/carbon anode composite for a lithium secondary battery, including the steps of: introducing silicon microparticles to a polymer solution or pitch solution and carrying out pulverization to prepare a mixture; subjecting the pulverized mixture to centrifugal separation, followed by drying, to prepare silicon nanoparticles surface-coated with a polymer or pitch; and coating a carbonaceous material with the silicon nanoparticles surface-coated with a polymer or pitch to obtain a silicon/carbon anode composite.

The silicon/carbon anode composite for a lithium secondary battery according to the present disclosure is obtained by coating the surface of silicon microparticles with a polymer or pitch and allowing the resultant product to be physicochemically bound to the surface of the carbonaceous material through a mechanofusion process, and thus needs no additional heat treatment and can be processed with ease, is prevented from volumetric swelling of silicon caused by lithium-ion intercalation and deintercalation, and can provide a battery with significantly improved capacity and life characteristics.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is an enlarged scanning electron microscopic (SEM) image (a) and general SEM image (b) of the silicon/carbon anode composite obtained according to Comparative Example 1.

FIG. 2 is an enlarged SEM image (a) and general SEM image (b) of the silicon/carbon anode composite obtained according to Example 2.

### DETAILED DESCRIPTION

Hereinafter, particular embodiments of the present disclosure will be explained in detail.

The present disclosure relates to a silicon/carbon anode composite for a lithium secondary battery, a method for preparing the same and a lithium secondary battery including the same.

As described earlier, an inorganic anode active material, such as silicon, is problematic in that it causes a large change in volume during the lithium intercalation and deintercalation, resulting in pulverization, and is separated from a current collector to cause a contact loss among the active materials. To solve such problems, the surface of graphite was coated with silicon to form a composite according to the related art. However, in this case, there is a problem in that the surface coating is not performed satisfactorily due to a difference in surface energy between silicon and graphite.

Under these circumstances, according to the present disclosure, a silicon/carbon anode composite for a lithium secondary battery is obtained by coating the surface of silicon microparticles with a polymer or pitch and allowing the resultant product to be physicochemically bound to the surface of the carbonaceous material through a mechanofusion process. Therefore, the silicon/carbon needs no additional heat treatment and can be processed with ease, is prevented from volumetric swelling of silicon caused by lithium-ion intercalation and deintercalation, and can provide a battery with significantly improved capacity and life characteristics.

Particularly, in one aspect of the present disclosure, there is provided a silicon/carbon anode composite for a lithium secondary battery, including: a carbonaceous material; and silicon nanoparticles bound to the surface of the carbonaceous material, wherein the silicon nanoparticles are surface-coated with a polymer or pitch.

The carbonaceous material may be incorporated in order to prevent a large change in volume of the silicon nanoparticles caused by the lithium-ion intercalation and deintercalation and to increase the ion conductivity so that the capacity and charge/discharge performance of a battery may be improved.

The carbonaceous material may have an average particle diameter of 0.1-50 μm, preferably 1-20 μm, and most preferably 5-15 μm. Herein, when the carbonaceous material has an average particle diameter of less than 0.1 μm, it cannot be coated with the silicon particles. On the other hand, when the carbonaceous material has an average particle diameter of larger than 50 μm, the resultant anode may be limited in functioning as an anode.

Particular examples of the carbonaceous material include at least one selected from the group consisting of artificial graphite, natural graphite, Ketjen black, carbon black, acetylene black, Super P and graphene. Preferably, the carbonaceous material may be artificial graphite, natural graphite, carbon black or a mixture thereof, and more preferably, natural graphite or artificial graphite. Graphite may have a spherical shape.

The silicon nanoparticles may be coated on the surface of the carbonaceous material in an amount of 1-70 wt %, preferably 3-50 wt %, and most preferably 5-30 wt %. When the content of silicon is less than 5 wt %, it is not possible to realize the advantage of high specific capacity of silicon sufficiently. On the other hand, when the content of silicon is larger than 30 wt %, it is not possible to ensure high operation stability of the carbonaceous material.

The silicon nanoparticles may be coated on the surface of the carbonaceous material to a thickness of 500 nm to 3 μm.

The silicon nanoparticles may include silicon (Si) or silicon oxide (SiOx) (wherein 0.1≤x≤10), and may have an average particle size of 10-800 nm, preferably 280-700 nm, more preferably 370-610 nm, and most preferably, 450-530 nm.

When the average particle size of the silicon nanoparticles is less than 10 nm, the silicon nanoparticles have an increased surface area to cause the aggregation of the silicon nanoparticles among themselves, and the aggregated silicon nanoparticles may be bound non-uniformly to the surface of the carbonaceous material in the state of large lumps to cause a drop in battery capacity. On the other hand, when the silicon nanoparticles have an average particle size of larger than 800 nm, the particle size becomes similar to the particle size of the carbonaceous material to generate repulsion force, and thus the silicon nanoparticles may not be coated uniformly and evenly on the surface of the carbonaceous material.

The weight ratio of the silicon nanoparticles: polymer or pitch may be 1:0.005-0.3, preferably 1:0.007-0.1, more preferably 1:0.008-0.07, and most preferably, 1:0.01-0.04.

Particularly, when the weight ratio of the polymer or pitch is less than 0.005, the surface of the carbonaceous material cannot be coated sufficiently with the silicon nanoparticles to cause a large change in volume during the charge/discharge, resulting in a pulverization phenomenon and a contact loss among the active materials, and the coatability on the surface of the carbonaceous material may be degraded. On the contrary, when the weight ratio is larger than 0.3, the surfaces of the silicon nanoparticles may be excessively coated with the polymer or pitch to interrupt lithium-ion intercalation and deintercalation, resulting in significant degradation of the capacity and charge/discharge performance of a battery.

The polymer or pitch may be coated on the surfaces of the silicon nanoparticles to a thickness of 0.1-50 nm, preferably 0.5-10 nm, and most preferably 1-5 nm.

When the thickness of the polymer or pitch is less than 0.1 nm, the binding force between the silicon nanoparticles and the carbonaceous material is significantly weak, resulting in a structural collapse caused by the volumetric swelling of the silicon nanoparticles. On the other hand, when the thickness of the polymer or pitch is larger than 50 nm, the lithium-ion migration channel becomes long to cause degradation of conductivity and an increase in resistance.

The polymer may function to increase the adhesive force between the carbonaceous material and the silicon nanoparticles without any heat treatment and to provide uniform surface tension by reducing the difference in surface tension from graphite during a dry coating process. Particular examples of the polymer may include at least one selected from the group consisting of polyacrylonitrile, polyethylene oxide, polypropylene oxide, polyethylene glycol, polyvinyl alcohol, polyacrylamide, poly (methyl methacrylate) and poly (methyl ether acrylate), preferably at least one selected from the group consisting of polyacrylonitrile, poly (methyl methacrylate) and poly (methyl ether acrylate), and most preferably polyacrylonitrile.

The pitch may be at least one selected from the group consisting of coal-based pitch, petroleum-based pitch and cokes, preferably petroleum-based pitch. Particularly, the petroleum-based pitch can induce strong surface bonding with the carbonaceous material through the coating on the surfaces of the silicon nanoparticles, as compared to the other types of pitch, and has a high softening point of 150-250° C. to impart excellent thermal stability, resulting in an increase battery capacity.

The silicon/carbon anode composite may include silicon nanoparticles bound to the surface of the carbonaceous material through the physicochemical binding caused by mechanofusion at 1000-5000 rpm for 10-60 minutes.

In another aspect of the present disclosure, there is provided an anode active material for a lithium secondary battery including the silicon/carbon anode composite according to the present disclosure.

In still another aspect of the present disclosure, there is provided an anode for a lithium secondary battery including the anode active material according to the present disclosure.

In still another aspect of the present disclosure, there is provided a lithium secondary battery including the anode according to the present disclosure.

In still another aspect of the present disclosure, there is provided a device which includes the lithium secondary battery according to the present disclosure and is any one selected from communication devices, transport devices and energy storage devices.

In still another aspect of the present disclosure, there is provided an electric device which includes the anode for a lithium secondary battery according to the present disclosure and is any one selected from electric vehicles, hybrid electric vehicles, plug-in hybrid electric vehicles and electric power storage devices.

In yet another aspect of the present disclosure, there is provided a method for preparing a silicon/carbon anode composite for a lithium secondary battery, including the steps of: introducing silicon microparticles to a polymer solution or pitch solution and carrying out pulverization to prepare a mixture; subjecting the pulverized mixture to centrifugal separation, followed by drying, to prepare silicon nanoparticles surface-coated with a polymer or pitch; and coating a carbonaceous material with the silicon nanoparticles surface-coated with a polymer or pitch to obtain a silicon/carbon anode composite.

The mixture may have a weight ratio of the silicon nanoparticles: polymer or pitch of 1:0.005-0.3, preferably 1:0.007-0.1, more preferably 1:0.008-0.07, and most preferably, 1:0.01-0.04.

In the step of preparing silicon nanoparticles surface-coated with a polymer or pitch, the drying may be carried out at a temperature of 50-800° C. for 1-10 hours, preferably at a temperature of 70-400° C. for 2-6 hours, and most preferably at a temperature of 50-100° C. for 3-5 hours.

The step of preparing a silicon/carbon anode composite may include carrying out mechanofusion at 1000-5000 rpm for 10-60 minutes, preferably at 1900-3800 rpm for 20-40 minutes, and most preferably at 2700-3300 rpm for 25-35 minutes.

Preferably, although it is not clearly described in the following Examples and Comparative Example, particularly, the silicon/carbon anode composite prepared by applying the following eight conditions in the method for preparing a silicon/carbon anode composite according to the present disclosure was evaluated in terms of the binding force of silicon nanoparticles on the surface of the carbonaceous material, surface coverage characteristics and electrochemical charge/discharge characteristics of the anode.

As a result, unlike the other conditions and numerical ranges, it is shown that when all of the following eight conditions are satisfied, the silicon/carbon anode composite shows excellent binding force between the carbonaceous material and silicon nanoparticles and surface coverage characteristics even under a high temperature and high pressure condition, any side reactions of the electrode and interfacial resistance are not generated, and the electrode shows significantly improved electrochemical stability.
1) The carbonaceous material is natural graphite or artificial graphite having an average particle diameter of 5-15 μm, 2) the silicon nanoparticles are coated on the surface of the carbonaceous material in an amount of 3-50 wt %, 3) the silicon nanoparticles are surface-coated with a polymer, 4) the silicon nanoparticle is silicon (Si) and has an average particle size of 370-610 nm, 5) the mixture has a weight ratio of the silicon nanoparticles: polymer of 1:0.008-0.07, 6) the polymer is coated on the surfaces of the silicon nanoparticles to a thickness of 0.5-10 nm, 7) the polymer is polyacrylonitrile, and 8) the step of preparing a silicon/carbon anode composite comprises carrying out mechanofusion at 1900-3800 rpm for 20-40 minutes to allow the silicon nanoparticles to be bound to the surface of the carbonaceous material through physicochemical binding.

However, if any one of the above eight conditions is not satisfied, the silicon nanoparticles bound to the surface of the carbonaceous material is lost partially under a high temperature and high pressure condition, or cannot be bound uniformly and evenly due to poor binding force and surface coverage characteristics. As a result, side reactions of the electrode and interfacial resistance are generated, and the electrochemical stability of the electrode is degraded rapidly.

More preferably, although it is not clearly described in the following Examples and Comparative Example, the silicon/carbon anode composite prepared by applying the following more preferred conditions in the method for preparing a silicon/carbon anode composite according to the present disclosure was used to obtain a lithium secondary battery by using a conventional method. Then, the lithium secondary battery was charged/discharged 500 times, and the hardness, BET surface area and swelling ratio of the silicon/carbon anode composite and the capacity retention and energy density of the lithium secondary battery were evaluated.

As a result, unlike the other conditions and numerical ranges, it is shown that when the following six conditions are satisfied, the silicon/carbon anode composite shows high hardness, a low BET surface area and a low swelling ratio upon the initial charge/discharge, and maintains its physical properties with no rapid degradation even after 500 charge/discharge cycles. It is also shown that the lithium secondary battery using the silicon/carbon anode composite maintains high energy density even after 500 charge/discharge cycles, and the battery shows excellent capacity and life characteristics.
1) The silicon nanoparticles are coated on the surface of the carbonaceous material in an amount of 5-30 wt %, 2) the silicon nanoparticles have an average particle size of 450-530 nm, 3) the mixture has a weight ratio of the silicon nanoparticles: polymer of 1:0.01-0.04, 4) the drying is carried out at a temperature of 50-100° C. for 3-5 hours in the step of preparing silicon nanoparticles surface-coated with a polymer or pitch, 5) the polymer is coated on the surfaces of the silicon nanoparticles to a thickness of 1-5 nm, and 6) the step of preparing a silicon/carbon anode composite comprises carrying out mechanofusion at 2700-3300 rpm for 25-35 minutes to allow the silicon nanoparticles to be bound to the surface of the carbonaceous material through physicochemical binding.

However, if any one of the above six more preferred conditions is not satisfied, the silicon/carbon anode composite undergoes degradation of hardness as the number of charge/discharge cycles is increased, and the binding force of the carbonaceous material or silicon nanoparticles is reduced to cause an increase in BET surface area and swelling ratio, resulting in significant degradation of mechanical properties. In addition, after 300 charge/discharge cycles, it is shown that the lithium secondary battery shows significantly low energy density, and the electrode shows poor capacity and life characteristics.

Hereinafter, the present disclosure will be explained in more detail with reference to Examples, but the scope of the present disclosure is not limited thereto.

### Example 1: Preparation of Silicon/carbon Anode Composite

First, silicon microparticles having an average particle diameter of 1-10 μm were introduced to a polyacrylonitrile (PAN) polymer solution including PAN polymer and dimethyl formamide solvent at a weight ratio of 1:500 and pulverized to an average particle size of 500 nm. Herein, the weight ratio of the pulverized silicon nanoparticles: PAN was 1:0.02. Then, the pulverized silicon nanoparticles were subjected to centrifugal separation and dried at 100° C. for 3 hours to obtain Si@PAN particles including silicon nanoparticles surface-coated with PAN polymer to a thickness of 1 nm.

After that, 10 wt % of the Si@PAN particles were mixed with 90 wt % of commercially available natural graphite having an average particle diameter of 5-15 μm, and surface coating was carried out by using a mechanofusion instrument at 3000 rpm for 30 minutes to obtain a silicon/carbon anode composite having a structure of graphite surface-coated with Si@PAN particles.

### Example 2: Preparation of Silicon/Carbon Anode Composite

A silicon/carbon anode composite was obtained in the same manner as Example 1, except that pitch was used instead of the PAN polymer.

### Comparative Example 1: Preparation of Silicon/Carbon Anode Composite

A silicon/carbon anode composite was obtained in the same manner as Example 1, except that the PAN polymer solution was not used, and silicon particles having an average particle size of 500 nm were mixed with graphite at a weight ratio of 10:90.

### Test Example 1: Scanning Electron Microscopy (SEM) Analysis of Silicon/Carbon Anode Composite

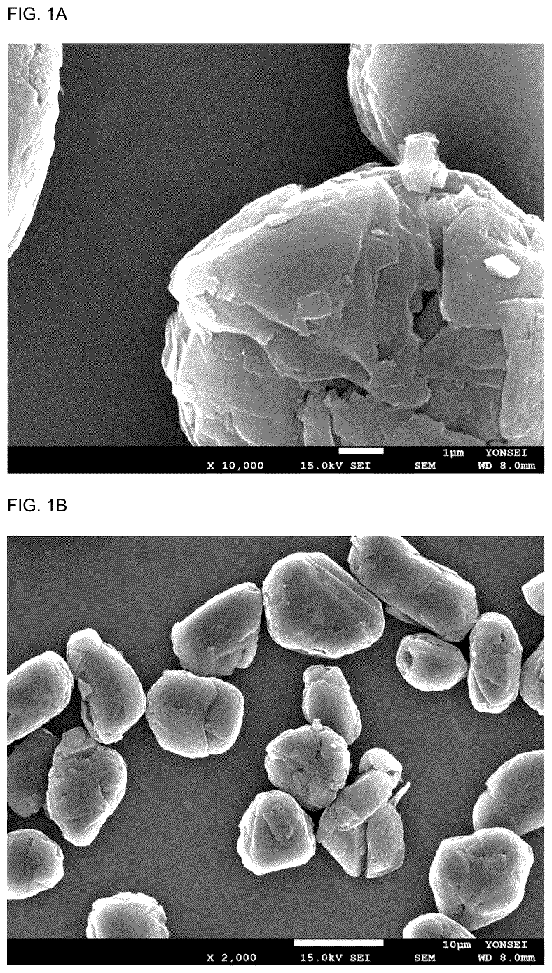

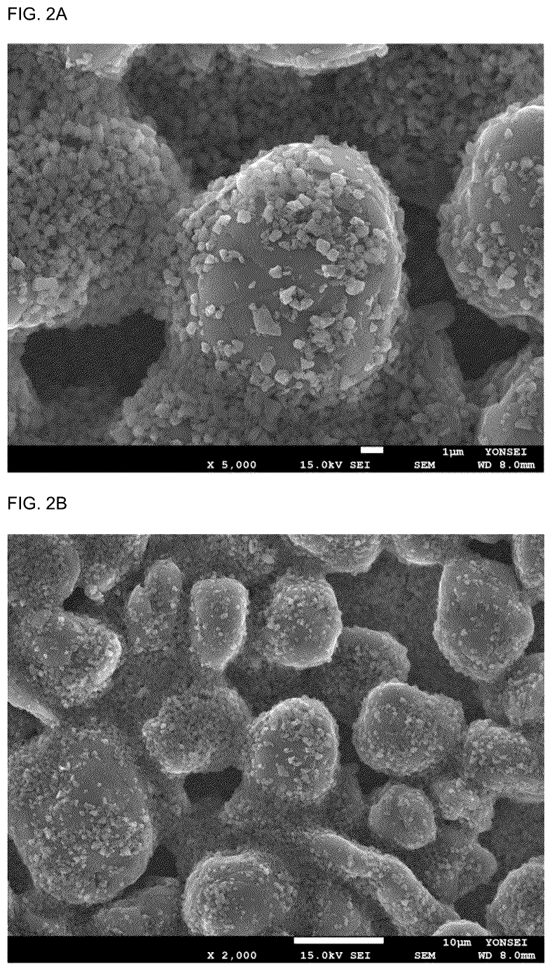

To determine the structure and shape of the silicon/carbon anode composite prepared from each of Example 1 and Comparative Example 1, scanning electron microscopy (SEM) analysis was carried out. The results are shown in FIG. 1 and FIG. 2.

FIG. 1 is an enlarged scanning electron microscopic (SEM) image (a) and general SEM image (b) of the silicon/carbon anode composite obtained according to Comparative Example 1. Referring to FIG. 1, it can be seen that silicon particles are little coated on the surface of graphite, and thus the smooth graphite surface is exposed as it is.

FIG. 2 is an enlarged SEM image (a) and general SEM image (b) of the silicon/carbon anode composite obtained according to Example 2. Referring to FIG. 2, it can be seen that the graphite surface is coated uniformly and evenly with silicon particles to realize excellent surface coatability.

### Test Example 2: Analysis of Initial Discharge Capacity and Capacity Retention of Silicon/Carbon Anode Composite

A lithium secondary battery was obtained through a conventional method by using the silicon/carbon anode composite prepared from each of Examples 1 and 2 and Comparative Example 1 as an anode, lithium metal as a cathode and a polyethylene porous membrane as a separator. Each lithium secondary battery was charged/discharged 50 times under the condition of room temperature at 0.5 C/0.5 C to analyze the initial discharge capacity and capacity retention. The results are shown in the following Table 1.

TABLE 1

| Material | Initial discharge capacity | | Capacity retention @50^{th} cycle |
|---|---|---|---|
| Ex. 1 | 530 | mAh/g | 90% |
| Ex. 2 | 500 | mAh/g | 85% |
| Comp. Ex. 1 | 230 | mAh/g | 30% |

According to the results of Table 1, it can be seen that the battery of Example 1 shows significantly higher initial discharge capacity and capacity retention values as compared to Comparative Example 1, since the graphite surface is uniformly surface-coated with silicon particles surface-coated with PAN polymer to a thickness of 1 nm.

In addition, in the case of Example 2, it can be seen that pitch used instead of PAN polymer functions as an adhesive between the silicon particles and graphite surface to increase the binding force between them, and then pitch carbonized through heat treatment is used as an electrode active material to provide improved initial discharge capacity and capacity retention as compared to Comparative Example 1.

What is claimed is:

1. A silicon/carbon anode composite for a lithium secondary battery, comprising:
a carbonaceous material; and
silicon nanoparticles bound to the surface of the carbonaceous material, wherein the silicon nanoparticles are surface-coated with a polymer or pitch.

2. The silicon/carbon anode composite for a lithium secondary battery according to claim 1, wherein the carbonaceous material is at least one selected from the group consisting of artificial graphite, natural graphite, Ketjen black, carbon black, acetylene black, Super P and graphene.

3. The silicon/carbon anode composite for a lithium secondary battery according to claim 1, wherein the silicon nanoparticles are coated on the surface of the carbonaceous material in an amount of 1-70 wt %.

4. The silicon/carbon anode composite for a lithium secondary battery according to claim 1, wherein the silicon nanoparticles comprise silicon (Si) or silicon oxide (SiOx) (wherein 0.1≤x≤10), and have an average particle size of 10-800 nm.

5. The silicon/carbon anode composite for a lithium secondary battery according to claim 1, wherein the weight ratio of the silicon nanoparticles: polymer or pitch is 1:0.005-0.3.

6. The silicon/carbon anode composite for a lithium secondary battery according to claim 1, wherein the polymer or pitch is coated on the surfaces of the silicon nanoparticles to a thickness of 0.1-50 nm.

7. The silicon/carbon anode composite for a lithium secondary battery according to claim 1, wherein the polymer is at least one selected from the group consisting of polyacrylonitrile, polyethylene oxide, polypropylene oxide, polyethylene glycol, polyvinyl alcohol, polyacrylamide, poly (methyl methacrylate) and poly (methyl ether acrylate).

8. The silicon/carbon anode composite for a lithium secondary battery according to claim 1, wherein the pitch is at least one selected from the group consisting of coal-based pitch, petroleum-based pitch and cokes.

9. The silicon/carbon anode composite for a lithium secondary battery according to claim 1, which comprises silicon nanoparticles bound to the surface of the carbonaceous material through the physicochemical binding caused by mechanofusion at 1000-5000 rpm for 10-60 minutes.

10. An anode active material for a lithium secondary battery comprising the silicon/carbon anode composite as defined in claim 1.

11. An anode for a lithium secondary battery comprising the anode active material as defined in claim 10.

12. A lithium secondary battery comprising the anode as defined in claim 11.

13. A device which comprises the lithium secondary battery as defined in claim 12 and is any one selected from communication devices, transport devices and energy storage devices.

14. An electric device which comprises the anode for a lithium secondary battery as defined in claim 11 and is any one selected from electric vehicles, hybrid electric vehicles, plug-in hybrid electric vehicles and electric power storage devices.

15. A method for preparing a silicon/carbon anode composite for a lithium secondary battery, comprising the steps of:
introducing silicon microparticles to a polymer solution or pitch solution and carrying out pulverization to prepare a mixture;
subjecting the pulverized mixture to centrifugal separation, followed by drying, to prepare silicon nanoparticles surface-coated with a polymer or pitch; and
coating a carbonaceous material with the silicon nanoparticles surface-coated with a polymer or pitch to obtain a silicon/carbon anode composite.

16. The method for preparing a silicon/carbon anode composite for a lithium secondary battery according to claim 15, wherein the mixture has a weight ratio of the silicon nanoparticles: polymer or pitch of 1:0.005-0.3.

17. The method for preparing a silicon/carbon anode composite for a lithium secondary battery according to claim 15, wherein the drying is carried out at a temperature of 50-800° C. for 1-10 hours, in the step of preparing silicon nanoparticles surface-coated with a polymer or pitch.

18. The method for preparing a silicon/carbon anode composite for a lithium secondary battery according to claim 15, wherein the step of preparing a silicon/carbon anode composite comprises carrying out mechanofusion at 1000-5000 rpm for 10-60 minutes.

19. The method for preparing a silicon/carbon anode composite for a lithium secondary battery according to claim 15,
wherein the carbonaceous material is natural graphite or artificial graphite having an average particle diameter of 5-15 μm,
the silicon nanoparticles are coated on the surface of the carbonaceous material in an amount of 3-50 wt %,
the silicon nanoparticles are surface-coated with a polymer,
the silicon nanoparticle is silicon (Si) and has an average particle size of 370-610 nm,
the mixture has a weight ratio of the silicon nanoparticles: polymer of 1:0.008-0.07,
the polymer is coated on the surfaces of the silicon nanoparticles to a thickness of 0.5-10 nm,
the polymer is polyacrylonitrile, and
the step of preparing a silicon/carbon anode composite comprises carrying out mechanofusion at 1900-3800 rpm for 20-40 minutes to allow the silicon nanoparticles to be bound to the surface of the carbonaceous material through physicochemical binding.

20. The method for preparing a silicon/carbon anode composite for a lithium secondary battery according to claim 19,
wherein the silicon nanoparticles are coated on the surface of the carbonaceous material in an amount of 5-30 wt %,
the silicon nanoparticles have an average particle size of 450-530 nm,
the mixture has a weight ratio of the silicon nanoparticle: polymer of 1:0.01-0.04,
the drying is carried out at a temperature of 50-100° C. for 3-5 hours in the step of preparing silicon nanoparticles surface-coated with a polymer or pitch,
the polymer is coated on the surfaces of the silicon nanoparticles to a thickness of 1-5 nm, and
the step of preparing a silicon/carbon anode composite comprises carrying out mechanofusion at 2700-3300 rpm for 25-35 minutes to allow the silicon nanoparticles to be bound to the surface of the carbonaceous material through physicochemical binding.
